(19) United States
(12) Patent Application Publication
(10) Pub. No.: US 2008/0202866 A1
(43) Pub. Date: Aug. 28, 2008

(54) Bicycle brake

(75) Inventor: Marco Caiazzo, Torri di Quartesolo - VI (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.R.L., Vicenza (IT)

(21) Appl. No.: 12/020,279

(22) Filed: Jan. 25, 2008

Related U.S. Application Data
(63) Continuation of application No. PCT/IT2005/000710, filed on Dec. 2, 2005.

(51) Int. Cl. B62L 1/16; F16C 1/10

(52) U.S. Cl. 188/24.12; 74/502.2

(57) ABSTRACT

The invention relates to a bicycle brake, having a first lever that comprises an actuation arm for connecting to an inner cable of a brake cable and a braking arm for supporting a brake pad. The brake also has a second lever that comprises an actuation arm for connecting to a sheath of the brake cable and a braking arm for supporting a brake pad. The actuation arm of the first lever has two side by side branches, a distal one and a proximal one with respect to the brake cable.

### CROSS REFERENCE TO RELATED APPLICATIONS

This application is a continuation of International Patent Application No. PCT/IT2005/000710, filed Dec. 2, 2005, which is incorporated by reference as if fully set forth.

### FIELD OF INVENTION

The present invention relates to a bicycle brake mountable on a bicycle frame at the rear wheel or on a bicycle's fork at the front wheel. The brake comprises two levers bearing respective brake pads that, in response to actuation of a control lever, typically located at a bicycle's handlebar, and through a sheathed cable (Bowden cable), pivot to clamp the brake pads about the rim of one of the bicycle wheels to stop it.

### BACKGROUND

Bicycle brakes are known wherein a lever is directly actuated by the sheathed cable, while the other lever is actuated by a cam pivoted on the lever directly actuated by the sheathed cable.

The present invention however relates to a type of bicycle brake comprising a first swinging lever having an actuation arm connected to an inner cable of a sheathed brake cable and a second swinging lever having an actuation arm connected to the sheath of the brake cable.

Two types of brakes of the above kind are known. A first type is the single pivot type where both levers are pivoted about a single central pivot that also serves as an attachment to the bicycle frame or fork. A second type is the dual pivot type where one of the two levers, usually the second one, is pivoted around a central pivot that also serves as an attachment to the bicycle, while the other lever, usually the first lever, is pivoted about a second pivot on a support body fixed to the central pivot.

In both types, in the second lever the area that attaches to the cable sheath and thus the actuation arm are on the same side, with respect to the wheel and thus with respect to the central pivot, as the area for supporting the pad and thus as the braking arm, while in the first lever the actuation arm is on the opposite side of the braking arm with respect to the wheel.

As a consequence, the second lever is essentially V-shaped, wherein the actuation and braking arms form an angle between them that faces away from the wheel. A reinforcing beam can possibly be provided extending between the two arms.

The first lever, conversely, has a slightly curved shape, the actuation and braking arms forming an obtuse angle between them that faces the wheel. The first lever does not comprise a similar reinforcing beam, since it would take up the space between the pads that is intended for receiving the wheel.

An object at the basis of the present invention is to improve the stress distribution in a bicycle brake.

### SUMMARY

The invention relates to a bicycle brake, wherein the actuation arm of a first lever thereof comprises two side by side branches, a distal one and a proximal one with respect to the brake cable.

### BRIEF DESCRIPTION OF THE DRAWINGS

Further features and advantages of the invention will become clearer from the description of some preferred embodiments, made with reference to the attached drawings, wherein like reference numerals refer to like elements and wherein:

FIG. 1 shows a perspective view of a single pivot brake according to the invention,

FIG. 2 shows a front view of a first lever of the brake of FIG. 1;

FIG. 3 shows a front view of a second lever of the brake of FIG. 1;

FIG. 4 shows a front view of an alternative embodiment of the second lever of FIG. 3;

FIG. 5 shows a perspective view of a dual pivot brake according to the invention;

FIG. 6 shows a front view of a first lever of the brake of FIG. 5;

FIG. 7 shows a front view of a second lever of the brake of FIG. 5; and

FIG. 8 shows a front view of a support body of the brake of FIG. 5.

### DETAILED DESCRIPTION OF THE PREFERRED EMBODIMENTS

### Introduction To The Embodiments

The invention relates to a bicycle brake, comprising (i) a first lever having an actuation arm for connecting to an inner cable of a brake cable and a braking arm for supporting a brake pad, and (ii) a second lever having an actuation arm for connecting to a sheath of the brake cable and a braking arm for supporting a brake pad, wherein the actuation arm of the first lever comprises two side by side branches, a distal one and a proximal one with respect to the brake cable.

The Applicant has recognized that in the known brakes, the actuation arm of the first lever, having a single branch, is subjected to a notable bending stress when its end connected to the inner cable of the control cable is pulled thereby and forces the pad against the rim. By replacing the single branch with two side by side branches, during braking the distal branch with respect to the traction cable is instead essentially subjected to tensile stress only, and the proximal branch with respect to the traction cable is essentially subjected to compressive stress only. Since the brake levers are typically made of a material having a compression strength and a tensile strength considerably higher than the flexural strength, a stronger brake is obtained, which can also be lighter in weight because a smaller overall cross-section of the actuation arm of the first lever suffices.

Preferably the two branches merge at an area for connecting to the inner cable of the brake cable.

In such a manner an area of the actuation arm having a comparably large cross-section is defined, that turns out to be useful for attaching the end of the inner cable of the brake cable.

Analogously, the two branches may merge at a pivoting area of the first lever.

Furthermore, analogously a portion of the braking arm of the first lever, adjacent to the pivoting area of the first lever, may comprise two side by side branches, a distal one and a proximal one with respect to the brake cable. These branches during braking are also essentially subjected to tensile stress and compressive stress only, respectively, instead of to the bending stress in a plane perpendicular to the pivot of the first lever itself, if the branch were single.

Preferably, an area of the braking arm of the first lever, adjacent to an area for supporting the pad, comprises a single branch.

By making such an area having a single branch, it is possible to give it a sufficiently large cross-section area, while still keeping a small overall space taken up by the first lever, in order to also bear the bending stresses caused by the pad being drawn by the rotating wheel during braking. Such stresses are found in a plane parallel to the pivot of the first lever.

Advantageously the second lever comprises a reinforcing beam extending between the actuation arm and the braking arm.

According to an aspect also advantageous per se, the reinforcing beam merges with the actuation arm between an area for connecting to the sheath of the brake cable and an intermediate point of the actuation arm.

In such a manner the reinforcing beam is more efficient in bearing the bending stresses, in the plane parallel to the pivot axis of the second lever, caused by the pad being drawn by the rotating wheel during braking.

In one embodiment, the intermediate point is closer to a pivoting area of the second lever than to the area for connecting to the sheath of the brake cable.

In such a manner the reinforcing beam is even more efficient in bearing the bending stresses.

Preferably, in said embodiment the reinforcing beam has a curved pattern from the braking arm to the actuation arm in the plane perpendicular to the central pivot.

In one embodiment, the first lever and the second lever are pivoted about a single central pivot provided for attachment to the bicycle frame or fork, in other words the brake is a single pivot type.

In another embodiment, one of the levers, usually the second lever, is pivoted about a central pivot provided for attaching to the bicycle, while the other lever, usually the first lever, is pivoted about a second pivot on a support body fixed to the central pivot, in other words the brake is of the dual pivot type.

In order to keep the brake weight low still preserving suitable features of mechanical strength, according to an aspect of the invention that is also advantageous per se, the support body has an aperture between a hole for receiving the central pivot and a hole for receiving the second pivot.

### DETAILED DESCRIPTION

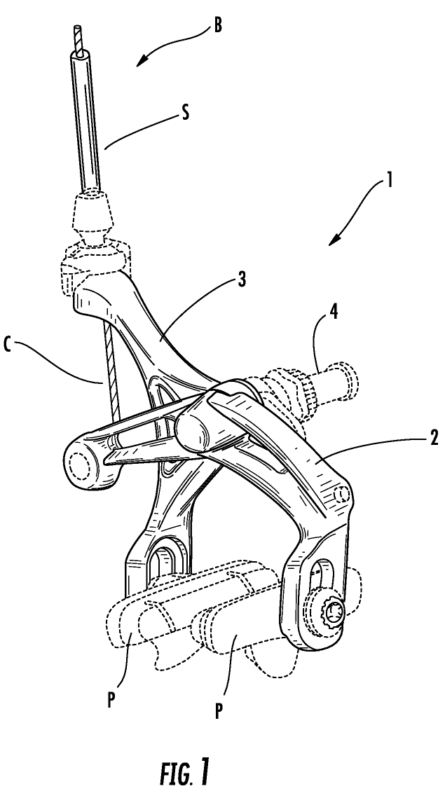

With reference to FIG. 1, a bicycle brake 1 of the single pivot type according to an embodiment of the invention comprises a first lever 2 and a second lever 3, both pivotable about a common central pivot 4.

The central pivot 4 is also used, besides for pivoting the levers 2, 3, as an attachment to the bicycle frame at the rear wheel or at the front fork.

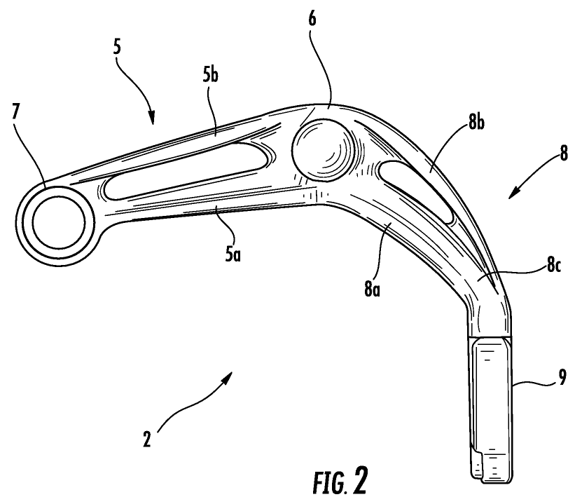

The first lever 2, better shown in FIG. 2, has an actuation arm 5 extending from pivoting area 6, for coupling to pivot 4, to area 7, for connecting—in a conventional manner—to an inner cable C of a brake cable B, and a braking arm 8 extending from the pivoting area 6 to an area 9 for supporting a brake pad P.

In a conventional manner, the brake cable B is an essentially inextensible Bowden cable, wherein the inner cable C is sheathed in a sheath S.

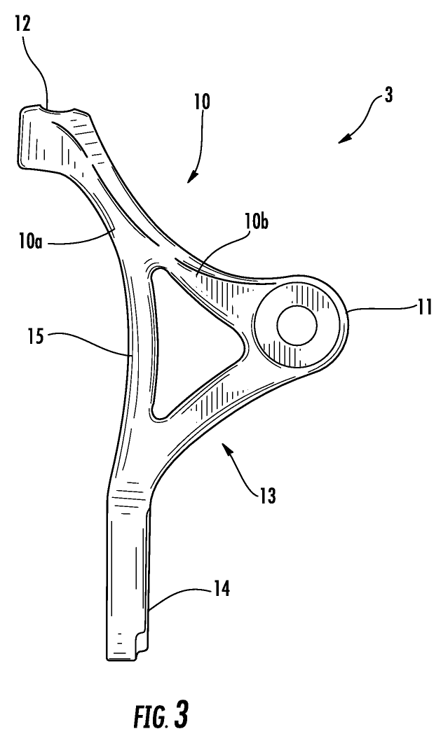

The second lever 3, better shown in FIG. 3, analogously has an actuation arm 10 extending from pivoting area 11 for attachment to pivot 4 to area 12 for connecting—in a conventional manner—to the sheath S of the brake cable B, and a braking arm 13 extending from the pivoting area 11 to an area 14 for supporting another brake pad P.

A reinforcing beam 15 extends between the actuation 10 and braking 13 arms of the second lever 3.

The pull of the brake cable B, in response to the actuation of a control lever, usually arranged at the ends of the handlebar, causes the two actuation arms 5, 10 to approach each other, thus causing the levers 2, 3 to pivot about the central pivot 4 whereby the brake pads P then clamp the rim of one of the bicycle wheels to stop it.

To this end, the braking arms 8, 13 of the two levers 2, 3 are curved or bent so that the areas 9, 14 for supporting the pads P extend essentially facing each other.

When the control lever actuation stops, return means, such as for example a wire spring having one or more turns or other elastic member, make the two levers 2, 3 return toward the rest position, wherein the pads P are further spaced from each other and therefore are not in contact with the wheel rim.

Because the brake cable B is attached on one side (to the left in FIG. 1) with respect to the central pivot 4, in the first lever 2 the actuation arm 5 is on the opposite side of the braking arm 8 with respect to the central pivot 4, and its arms 5, 8 form an obtuse angle between them that faces towards the wheel.

In the second lever 3, on the other hand, the actuation arm 10 is on the same side, with respect to the wheel and thus with respect to the central pivot 4, as the braking arm 13. The actuation 10 and braking 13 arms of the second lever 3 thus form an angle between them that faces away from the wheel.

As better shown in FIG. 2, the actuation arm 5 of the first lever 2 comprises two side by side branches, a distal branch 5a and a proximal branch 5b, wherein the terms “distal” and “proximal” are used with respect to the position of the brake cable B, that is arranged above the attachment areas 7, 12 in the brake orientation shown in the figures. The two branches 5a, 5b merge at area 7 for connecting to the inner cable C of the brake cable B, and at the pivoting area 6 of the first lever 2.

During actuation of brake 1, when the attachment area 7 of the first lever 2 is pulled by the inner cable C of the brake cable B towards lever 3 (upwards with reference to the figures) and pad P is forced against the rim, the distal branch 5a is subjected to bending stress, while the proximal branch 5b is subjected to compressive stress. The bending stresses in the two branches 5a, 5b are instead quite negligible, what is advantageous in that the flexural strength is typically well lower than the tensile strength and than the compression strength. It is worthwhile noting that if instead of the two distal and proximal branches 5a, 5b, a single branch actuation arm 5 were provided, it would be subjected to notable bending stresses in the plane orthogonal to the central pivot 4.

Moreover, the cross-section area of the individual branches 5a, 5b need only be sized to bear said tensile and compressive stresses, respectively. It follows that the cross-section area of the actuation arm 5 as a whole is smaller than what would be necessary if instead of the two distal and proximal branches 5a, 5b, a single branch actuation arm 5 were provided. Accordingly, the brake 1 as a whole is lighter with respect to its configuration according to the prior art.

Through the merging of the two branches at the connection area 7 and at the pivoting area 6, said areas have a comparably large cross-section, suitable for the means for connecting to the end of the inner cable C of the brake cable B and, respectively, to the central pivot 4.

In a portion adjacent to the pivoting area 6, the braking arm 8 of the first lever 2 also comprises a distal branch 8a and a proximal branch 8b arranged side by side, wherein again the terms “distal” and “proximal” are used with reference to the brake cable B in the mounted configuration of the brake 1.

During actuation of the brake 1, the braking arm 8 of the first lever is subjected to the reaction force (towards the right in the figures) applied by the wheel rim on pad P and thus on the supporting area 9. Through the described configuration having two branches 8a, 8b, the distal branch 8a is subjected to tensile stress, while the proximal branch 8b is subjected to compressive stress. The bending stresses in the two branches 8a, 8b are conversely quite negligible, with analogous advantages to those described in relation to the two branches 5a, 5b in the actuation arm 5.

Conversely, in the remaining portion the braking arm 8 comprises a single branch 8c, suitable to also bear the bending stresses in the plane parallel to the pivot 4 (perpendicular to the drawing sheet), caused by pad P being drawn by the rotating wheel.

As mentioned above, the second lever 3 comprises a reinforcing beam 15 extending between the actuation arm 10 and the braking arm 13.

As better shown in FIG. 3, the reinforcing beam 15 merges with the actuation arm 10 between the area 12 for connecting to the sheath S of the brake cable B and an intermediate, approximately central point of the actuation arm 10.

Since the reinforcing beam 15 does not extend to the area 12 for connecting to the sheath S of the brake cable B, rather to an intermediate point of the actuation arm 10, it is closer to the pivoting area 11 of the second lever 2. As a result, the reinforcing beam 15 is more efficient in bearing the bending stresses in the plane parallel to pivot 4 (perpendicular to the drawing sheet), caused by the pad P being drawn by the rotating wheel.

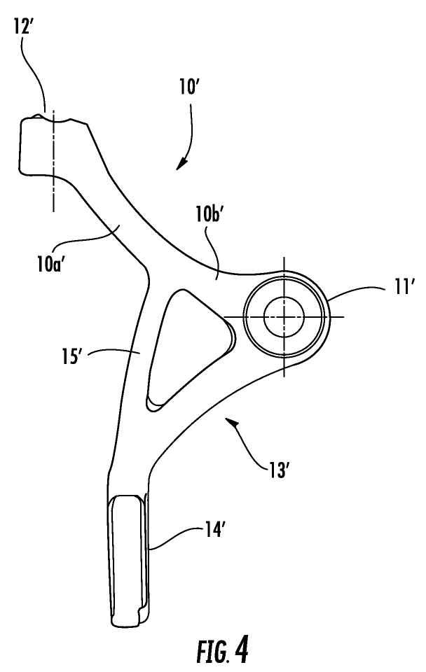

In an alternative embodiment of the second lever shown in FIG. 4, wherein analogous references are used, labelled with a prime, the reinforcing beam 15′ has a curved pattern from the braking arm 14′ to the actuation arm 10′ in the plane perpendicular to the central pivot (plane of the drawing sheet) and merges with the actuation arm 10′ in an intermediate point that is closer to the pivoting area 11′ of the second lever 3′ than to the area 12′ for connecting to the sheath S of the brake cable B.

The reinforcing beam 15′ is even more efficient in bearing the bending stresses in the plane parallel to the pivot 4 (perpendicular to the drawing sheet), caused by the pad P being drawn by the rotating wheel.

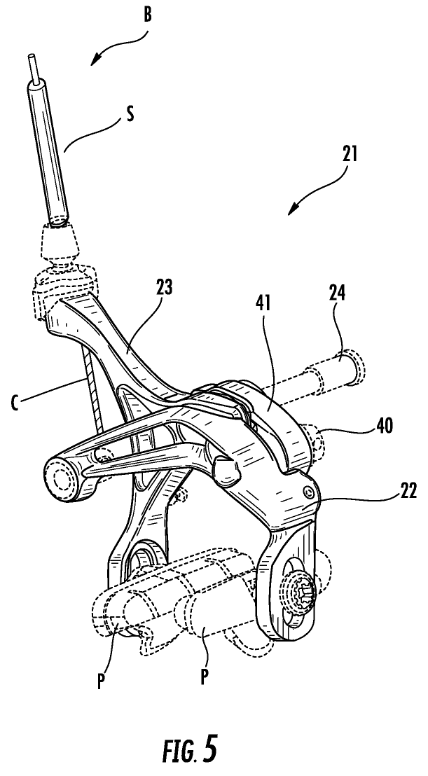

In FIG. 5 a bicycle brake 21 of the dual pivot type is shown, according to another embodiment of the invention, wherein its parts analogous to brake 1 described above are labelled with analogous references, increased by 20.

Brake 21 differs from brake 1 in that the second lever 23 is pivoted about central pivot 24, that also serves for attaching the brake 21 to the bicycle, while the first lever 22 is pivoted about a second pivot 40 on support body 41 fixed to the central pivot 24.

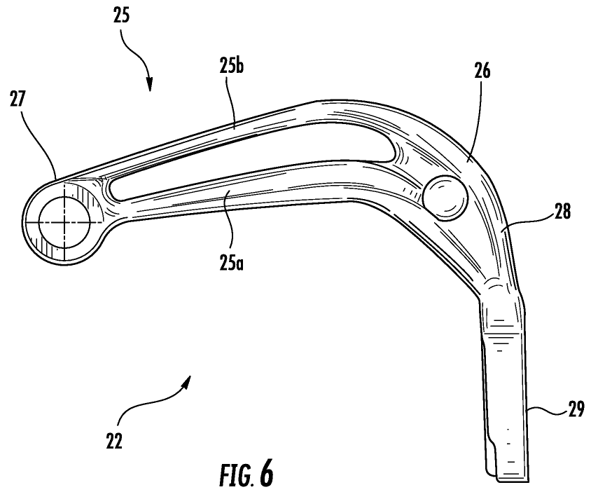

The first lever 22, better shown in FIG. 6, differs from the first lever 2 of FIG. 2, other than the different position of the pivoting area 26, in that the whole braking arm 28 is single branched. In a dual pivot brake such as brake 21, the ratio of the length of the actuation arm 25 to the length of the braking arm 28 is approximately 1.5:1. In contrast, such a ratio of a single pivot type brake such as brake 1, is about 1:1. The braking force being equal, the braking arm 28 of brake 21 is therefore subjected to a greater stress per unit length with respect to arm 8 of brake 1. It is accordingly proper that the whole braking arm 28 comprises a single branch, suitable to also bear the bending stresses in the plane parallel to pivot 26 (perpendicular to the drawing sheet), caused by the pad P being drawn by the rotating wheel.

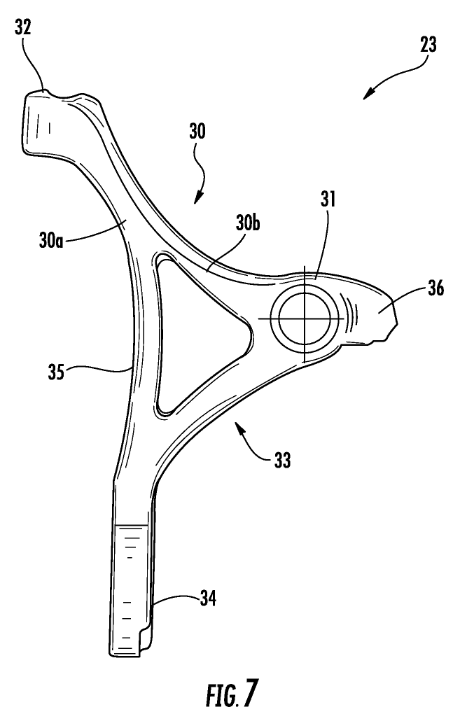

The second lever 23 of the dual pivot brake 21, better shown in FIG. 7, differs from the second lever 3 of the single pivot brake 1 in that it comprises a lug 36 extending from the pivoting area 31 on the opposite side with respect to the actuation 30 and braking 33 arms. Lug 36 cooperates with suitable means on the first lever 22 to balance the different forces caused by the different lengths of actuation arm 25 and braking arm 28 of the first lever 22.

It is also possible in this case to shape the reinforcing beam 35 as shown in FIG. 4.

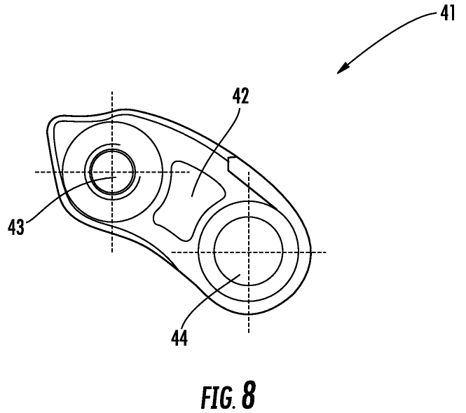

As shown in FIG. 8, the support body 41 has an aperture 42 between a hole 43 for receiving the central pivot 24 and a hole 44 for receiving the second pivot 40. Such an aperture 42 allows the weight of brake 21 to be kept low, still preserving suitable features of mechanical strength.

In both of the above described brakes 1, 21 the mutual position of the two levers 2, 3 or 3′, 22, 23 along the axis of the central pivot 4, 24 could be reversed.

Those skilled in the art will understand that the configuration of a portion of the braking arm 8 of the first lever 2 according to the two side by side branches 8a, 8b can also be advantageous irrespective of the configuration of the actuation arm 5, 25 of the first lever 2, 22 according to the two side by side branches 5a, 5b, 25a, 25b.

Also the various configurations of the second lever 3, 3′, 23 shown and described can be advantageous irrespective of the configuration of the actuation arm 5, 25 of the first lever 2, 22 according to the two side by side branches 5a, 5b, 25a, 25b.

What is claimed is:

1. Bicycle brake comprising:
(i) a first lever having an actuation arm for connecting to an inner cable of a brake cable and a braking arm for supporting a brake pad; and
(ii) a second lever having an actuation arm for connecting to a sheath of the brake cable and a braking arm for supporting a brake pad,
wherein the actuation arm of the first lever comprises two side by side branches, a distal one and a proximal one with respect to the brake cable.

2. Brake according to claim 1, wherein the two branches merge at an area for connecting to the inner cable of the brake cable.

3. Brake according to claim 1, wherein the two branches merge at a pivoting area of the first lever.

4. Brake according to claim 1, wherein a portion of the braking arm of the first lever, adjacent to the pivoting area of the first lever, comprises two side by side branches, a distal one and a proximal one with respect to the brake cable.

5. Brake according to claim 1, wherein an area of the braking arm of the first lever, adjacent to an area for supporting the pad, comprises a single branch.

6. Brake according to claim 1, wherein the second lever comprises a reinforcing beam extending between the actuation arm and the braking arm.

7. Brake according to claim 6, wherein the reinforcing beam merges with the actuation arm between an area for connecting to the sheath of the brake cable and an intermediate point of the actuation arm.

8. Brake according to claim 7, wherein the intermediate point is closer to a pivoting area of the second lever than to the area for connecting to the sheath of the brake cable.

9. Brake according to claim 7, wherein the reinforcing beam has a curved pattern from the braking arm to the actuation arm in the plane perpendicular to the central pivot.

10. Brake according to claim 1, wherein the first lever and the second lever, are pivoted about a single central pivot provided for attaching to the bicycle frame or fork.

11. Brake according to claim 1, wherein one of the levers is pivoted about a central pivot provided for attachment to the bicycle, while the other of the levers is pivoted about a second pivot on a support body fixed to the central pivot.

12. Brake according to claim 11, wherein the support body has an aperture between a hole for receiving the central pivot and a hole for receiving the second pivot.

13. Bicycle brake comprising:
(i) a first lever having an actuation arm for connecting to an inner cable of a brake cable and a braking arm for supporting a brake pad; and
(ii) a second lever having an actuation arm for connecting to a sheath of the brake cable and a braking arm for supporting a brake pad,
wherein a portion of the braking arm of the first lever, adjacent to the pivoting area of the first lever, comprises two side by side branches, a distal one and a proximal one with respect to the brake cable.

14. Bicycle brake comprising:
(i) a first lever having an actuation arm for connecting to an inner cable of a brake cable and a braking arm for supporting a brake pad; and
(ii) a second lever having an actuation arm for connecting to a sheath of the brake cable and a braking arm for supporting a brake pad,
wherein the actuation arm of the first lever comprises two side by side branches, a distal one and a proximal one with respect to the brake cable; a portion of the braking arm of the first lever, adjacent to the pivoting area of the first lever, comprises two side by side branches, a distal one and a proximal one with respect to the brake cable.

15. Bicycle brake comprising:
(i) a first lever having an actuation arm for connecting to an inner cable of a brake cable and a braking arm for supporting a brake pad; and
(ii) a second lever having an actuation arm for connecting to a sheath of the brake cable and a braking arm for supporting a brake pad, wherein the second lever comprises a reinforcing beam extending between the actuation arm and the braking arm, the reinforcing beam merging with the actuation arm between an area for connecting to the sheath of the brake cable and an intermediate point of the actuation arm.

16. Brake according to claim 15, wherein the intermediate point is closer to a pivoting area of the second lever than to the area for connecting to the sheath of the brake cable.

17. Brake according to claim 15, wherein the reinforcing beam has a curved pattern from the braking arm to the actuation arm in the plane perpendicular to the central pivot.

18. Bicycle brake comprising:
(i) a first lever having an actuation arm for connecting to an inner cable of a brake cable and a braking arm for supporting a brake pad; and
(ii) a second lever having an actuation arm for connecting to a sheath of the brake cable and a braking arm for supporting a brake pad, wherein the actuation arm of the first lever comprises two side by side branches, a distal one and a proximal one with respect to the brake cable, and wherein one of the levers is pivoted about a central pivot provided for attachment to the bicycle, while the other of the levers is pivoted about a second pivot on a support body fixed to the central pivot, the support body having an aperture between a first hole for receiving the central pivot and a second hole for receiving the second pivot.

19. A bicycle brake support body having a substantially oval shape and first and second ends, the body comprising a first hole disposed at the first end engagable with a central pivot for a first brake lever; a second hole disposed at a second end, engagable with a second pivot for a second brake lever; and an aperture disposed between the first and second holes.

20. A bicycle brake having first and second levers pivotable about at least one axis, said first lever comprising a bifurcated actuation arm having first and second branches, said first and second branches converging, at a first end, at a brake cable connection point and, at a second end, at a pivot point.

21. A bicycle brake having first and second levers pivotable about at least one axis, said first lever comprising an actuation arm and a braking arm integral with said actuating arm, said braking arm comprising a brake pad support and bifurcated first and second branches converging at said brake pad support.

22. A bicycle brake lever comprising a brake cable connection portion; a pivot portion; and an actuation arm integral therewith and extending therebetween, said actuation arm comprising two branches that converge at the connection portion and at the pivot portion.

23. The brake lever of claim 21 further comprising a braking arm extending from the pivot portion and terminating at a brake pad support, said braking arm comprising two branches that converge at the pivot portion and at the brake pad support.

24. A brake lever comprising a brake cable connecting portion, an actuation arm integral therewith, said actuation arm divergently extending away from the brake cable connecting portion, a first branch thereof extending towards a pivot portion and a second branch extending towards a brake pad support, the lever further comprising a braking arm extending from the pivot portion and converging with the second branch.

25. A brake lever having a main body of a substantially hollow triangular shape, the lever comprising:
a brake cable connecting portion located at a first end of the main body;
a pivot portion located at a second end of the main body; and
a brake pad support located at a third end of the main body.

26. A bicycle brake lever comprising:
a braking arm portion;
a pivot portion connected to the braking arm portion;
a brake cable connection portion; and
an actuation arm portion having two spaced apart branches that extend between the pivot portion and the brake cable connecting portion.

27. The brake lever of claim 25 wherein the braking arm portion has a free end that defines a brake pad support and spaced apart branches that extend between the pivot portion and the brake pad support.

28. A unitary brake lever comprising:
a pivot portion;
an actuation portion having spaced apart branches that extend between the pivot portion and a brake cable connecting portion formed at a free thereof; and
a braking portion that has spaced apart branches that extend between the pivot portion and a free end that defines a brake pad support.
